(19) United States
(12) Patent Application Publication
(10) Pub. No.: US 2026/0040152 A1
(43) Pub. Date: Feb. 5, 2026

(54) METHODS AND APPARATUS FOR MANAGEMENT OF TEMPORARY DEVICE IDENTITIES IN AMBIENT INTERNET OF THINGS (AIOT) SYSTEMS

(71) Applicant: InterDigital Patent Holdings, Inc., Wilmington, DE (US)

(72) Inventors: Martino Freda, Laval (CA); Erdem Bala, East Meadow, NY (US); Paul Marinier, Brossard (CA); Jongwoo Hong, New York, NY (US); Brian Martin, Farnham (GB); Remun Koirala, London (GB); Ahmed Mostafa, Ottawa (CA); Patrick Tooher, Montreal (CA)

(73) Assignee: InterDigital Patent Holdings, Inc., Wilmington, DE (US)

(21) Appl. No.: 18/794,572

(22) Filed: Aug. 5, 2024

(51) Int. Cl. H04W 28/26; H04W 24/10; H04W 68/02; H04W 76/20

(52) U.S. Cl. CPC H04W 28/26; H04W 24/10; H04W 68/02; H04W 76/20

(57) ABSTRACT

A WTRU may receive an AIoT inventory configuration information. The WTRU may receive an inventory trigger and determine, based at least on the trigger type and on the configuration, a first set of resources reserved for an unknown device and a second set of resources reserved for a known device. The WTRU may send an AIoT paging message including the inventory trigger type and information about the first set of resources and the second set of resources. The WTRU may receive, from a device, a first message using a first resource associated with the first set of resources, including a device ID. The WTRU may transmit a second message using a second resource also associated with the first set of resources, including the device ID received in the first message.

### BACKGROUND

In recent years, Internet of Things (IoT) has attracted much attention in the wireless communication world. More ‘things’ are expected to be interconnected for improving productivity efficiency and increasing comforts of life. Further reduction of size, complexity, and power consumption of IoT devices may enable the deployment of tens or even hundreds of billions of IoT devices for various applications and provide added value across the entire value chain. Manual replacement of batteries in IoT devices may lead to high maintenance cost, environmental issues, and even safety hazards for some use cases (e.g., wireless sensor in electric power and petroleum industry).

Considering the limited size and complexity required by practical applications for battery-less devices with no energy storage capability or devices with limited energy storage that do not need to be replaced or recharged manually, the output power of energy harvester is typically from 1 μW to a few hundreds of μW. Existing cellular devices may present peak power consumption of orders higher than 10 mW, adding a challenge when utilizing cellular devices for IoT applications that may require extremely low power consumption.

SUMMARY

In an Ambient IoT (AIoT) system, an AIoT device, such as a tag, may communicate with an intermediate node, which may be, e.g., a relay, a WTRU, a UE, or an IAB node. The intermediate node may communicate with the base station, processing and/or relaying information associated with one or more AIoT devices. The intermediate node may have the capability of communicating directly with the AIoT device, over the AIoT interface, e.g., using RFID. The intermediate node may process and then relay the information between the base station and the AIoT device. The communication between the nodes may be bidirectional, allowing for data and/or signaling in both directions.

A WTRU may be configured to perform the functions of a reader or an intermediate WTRU. The WTRU may page an AIoT device to request information, such as during an inventory procedure. In RFID, the paging is based on a long device ID, which is unique for a device. The use of a shorter temporary device ID, assigned by the Access Stratum (AS) layer, may be beneficial to make subsequent operations more resource efficient. However, there are shortcomings of this mechanisms in AIoT.

AIoT devices may not have the capability of storing the temporary IDs, e.g., due to limited storage space. The implementation of the functionality of receiving a temporary ID from the network and then saving it in local memory may be too complex for such simple AIoT devices which have limited processing capabilities and stringent power consumption. Due to power limitations, a device which is not energized may lose some of its storage, and the reader may have no knowledge of when this occurs, and no knowledge that a new temporary ID needs to be assigned to the device that lost its previous temporary ID. As a result of these factors, a need for a mechanism for assignment of a temporary AS layer device ID was identified.

A UE (e.g., reader) may assign a temporary AS layer ID to an AIoT device. The conditions associated to whether or not the UE should assign an AS device ID to a device may be based on the type of operation that triggered the UE to page the device. For example, a UE may determine whether to assign an AS layer device ID to a device based on the type of operation that was triggered by the core network and/or network. Specifically, a UE may initiate a random access procedure following a trigger from the upper layers, CN, or gNB (e.g., by receiving an RRC message, NAS message, application layer message, etc.). For example, if the UE is asked to perform inventory+command operation and has received subsequent command information for a device, it may assign an AS layer device ID. On the other hand, if the UE is asked to perform inventory only, it may not assign an AS layer device ID.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a diagram illustrating an example communications system in which one or more disclosed embodiments may be implemented;

FIG. 1B is a system diagram illustrating an example WTRU;

FIG. 1C is a system diagram illustrating the RAN and the CN according to an embodiment;

FIG. 1D is a system diagram illustrating the RAN and the CN according to an embodiment;

FIG. 2 illustrates an example of a call flow of an asset identification procedure using RFID devices;

FIG. 3 depicts the architecture of an example of a topology of an AIoT system-Topology 1;

FIG. 4 depicts the architecture of another example of a topology of an AIoT system-Topology 2;

FIG. 5 depicts the architecture of another example of a topology of an AIoT system-Topology 3;

FIG. 6 depicts the architecture of another example of a topology of an AIoT system-Topology 4;

FIG. 7 illustrates the AIoT random access framework; and

FIG. 8 illustrates the call flow of an example implemented in Topology 2.

### DETAILED DESCRIPTION

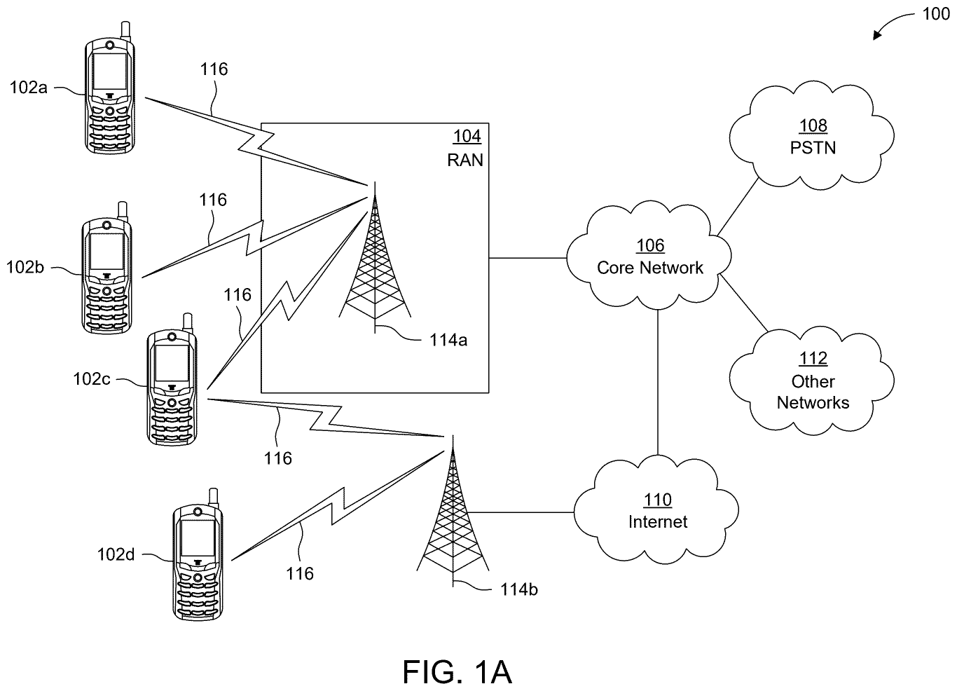

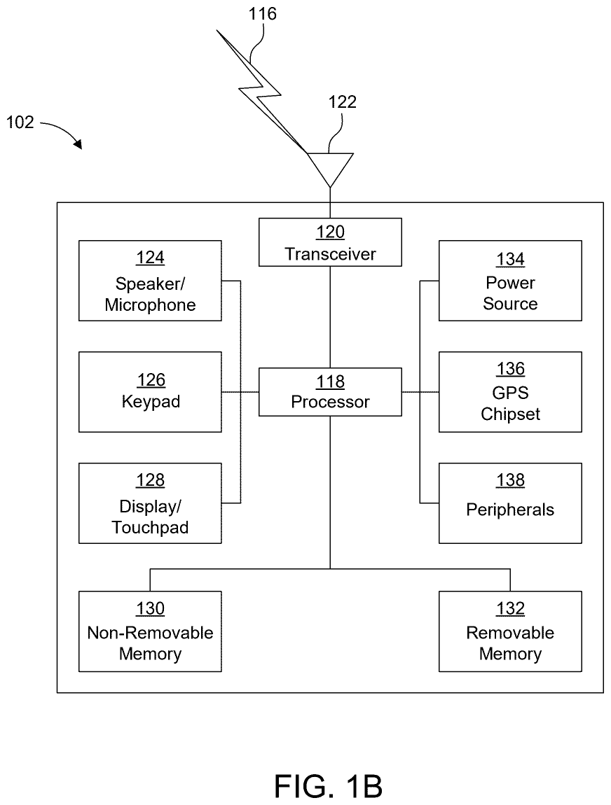

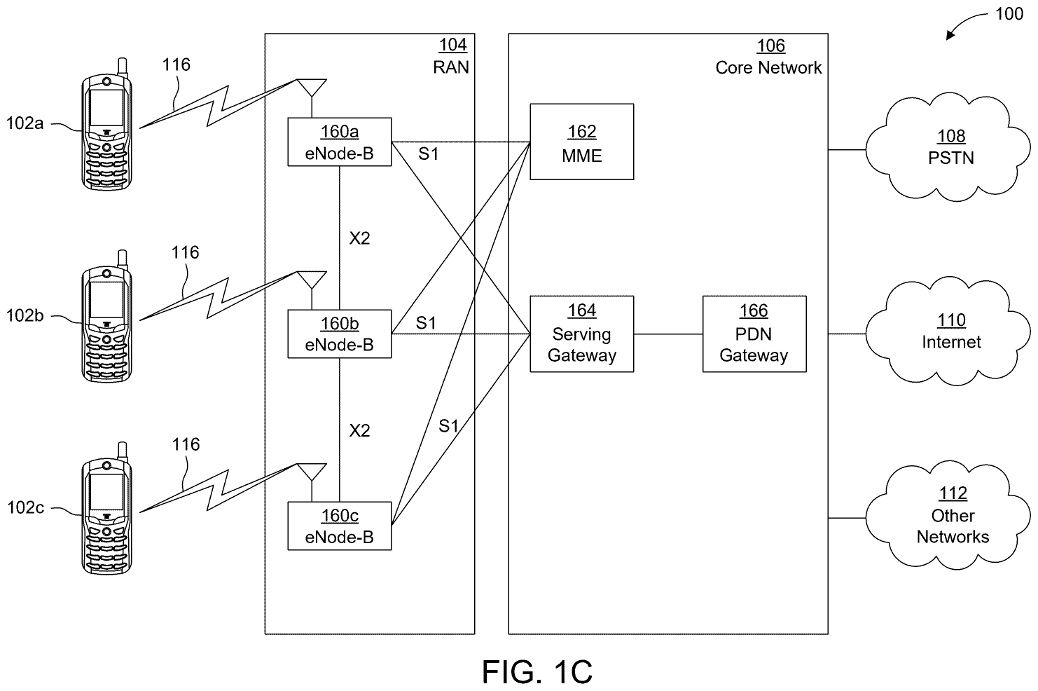

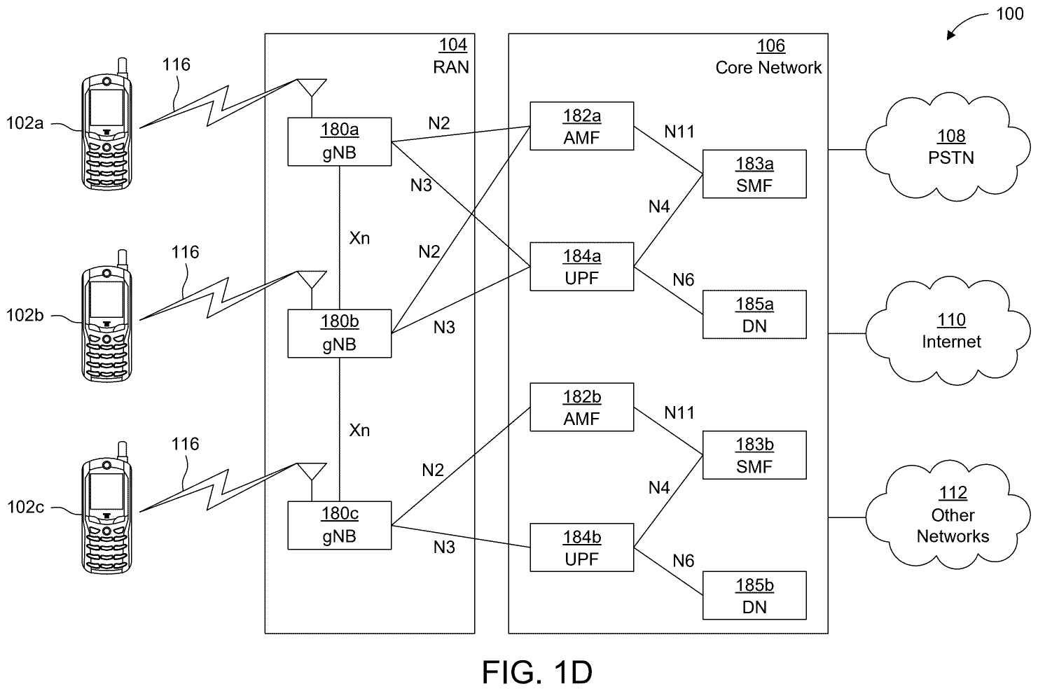

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHZ, 80 MHZ, and/or 160 MHz wide channels. The 40 MHZ, and/or 80 MHZ, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHZ, 10 MHZ, and 20 MHz bandwidths in the TV White Space (TVWS) spectrum, and 802.11ah supports 1 MHZ, 2 MHZ, 4 MHZ, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHZ, 8 MHZ, 16 MHZ, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHZ. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

In recent years, Internet of Things (IoT) has attracted much attention in the wireless communication world. More ‘things’ are expected to be interconnected for improving productivity efficiency and increasing comforts of life. Further reduction of size, complexity, and power consumption of IoT devices may enable the deployment of tens or even hundreds of billions of IoT devices for various applications and provide added value across the entire value chain. Manual replacement of batteries in IoT devices may lead to high maintenance cost, environmental issues, and even safety hazards for some use cases (e.g., wireless sensor in electric power and petroleum industry).

Considering the limited size and complexity required by practical applications for battery-less devices with no energy storage capability or devices with limited energy storage that do not need to be replaced or recharged manually, the output power of energy harvester is typically from 1 μW to a few hundreds of μW. Existing cellular devices may present peak power consumption of orders higher than 10 mW, adding a challenge when utilizing cellular devices for IoT applications that may require extremely low power consumption.

An example type of application is asset identification, which presently has to resort mainly to barcode and RFID in most industries. The main advantage of these two technologies is the ultra-low complexity and small form factor of the tags. However, the limited reading range of a few meters usually requires handheld scanning, which may lead to labor intensive and time-consuming operations, or RFID portals/gates, which may lead to costly deployments. In addition, the lack of interference management schemes may result in severe interference between RFID readers and capacity problems, especially in case of dense deployments. It may be difficult to support large-scale network with seamless coverage for RFID.

Radio Frequency Identification (RFID) systems are Internet of Things (IoT) systems comprising two types of devices, referred to as “tags” and “readers” or “interrogators”. RFID devices have at least one antenna that is used by the device to communicate with each other using signals. Different applications may take advantage of an RFID system such as inventory control, containers tracking, patient monitoring, pet finding, and children tracking, to name a few.

As an example, in an inventory control system, an interrogator device, may trigger multiple tag devices using a sequence of messages, to which the tag devices may respond to. In other words, the inventory procedure may comprise a single round of attempts of having each tag device respond or attempt to respond with its access ID or perform a random access procedure.

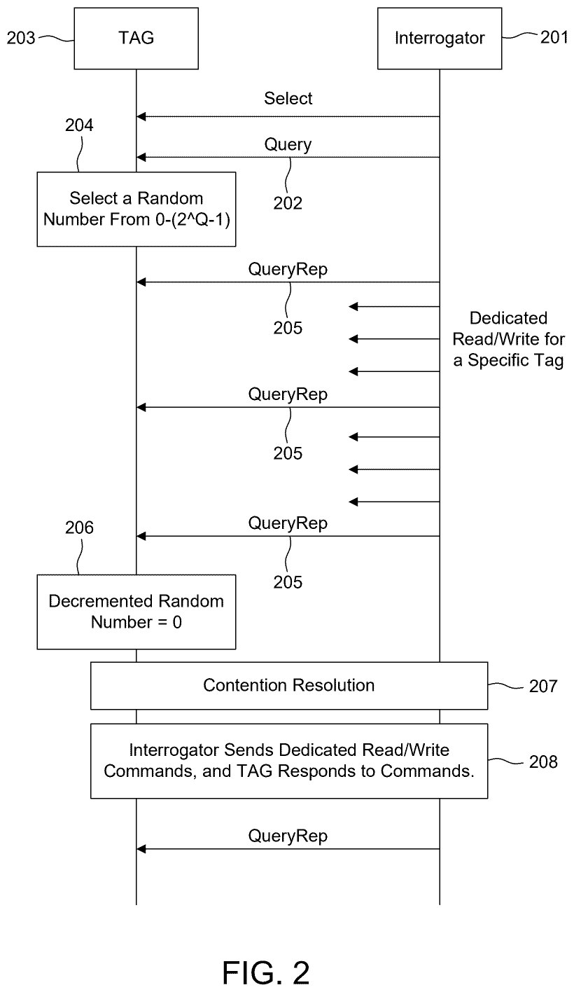

FIG. 2 illustrates an example of a call flow of an asset identification procedure using RFID devices.

In the inventory procedure, an interrogator or reader 201 may send a Query message 202 to energize all or a subset of tags 203. Following the Query message 202, the tag 203 may select a random number from 0-2^Q−1 204 and load its memory with that number. At each transmission of a QueryRep 205, the tag 203 decrements its counter until the counter reaches 0 206. When the counter reaches 0 206, the tag 203 may initiate a contention resolution procedure 207, which may include transmitting its device ID in the uplink, and waiting for confirmation of the device ID in the downlink (to address possible collision between multiple devices selecting the same random number). The interrogator (or reader) 201 may send multiple read/write commands 208 to a tag 203 that has passed the contention resolution, to which the tag may respond 208.

Different network topologies may be defined for an AIoT system.

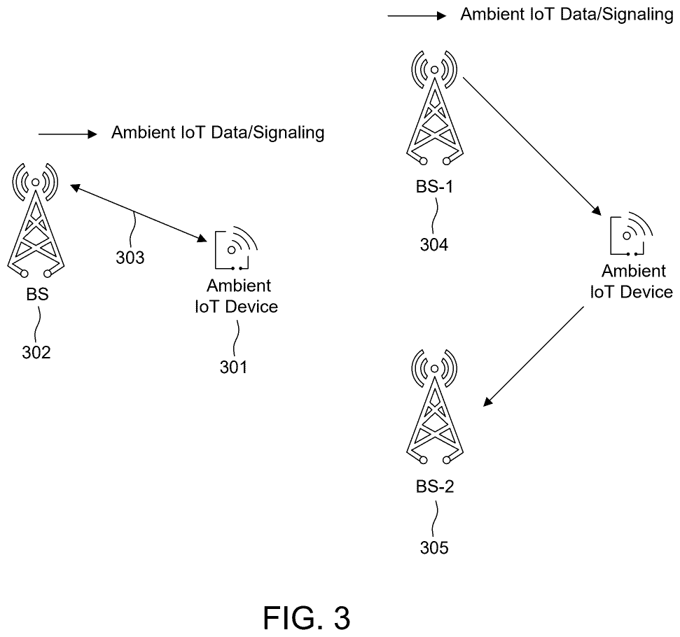

FIG. 3 depicts the architecture of an example of a topology of an AIoT system-Topology 1.

In topology 1, the AIoT device 301 may communicate with a base station (e.g., gNB, eNB) 302. The communication between the base station and the AIoT device may include data and/or signaling over the AIoT interface 303. In one example, the communication may be bidirectional, with one base station supporting the bidirectional communication. In another example, the communication may involve two base stations 304, 305, one base station 304 may be transmitting to a given AIoT device and another base station 305 may be receiving 305 from the same AIoT device.

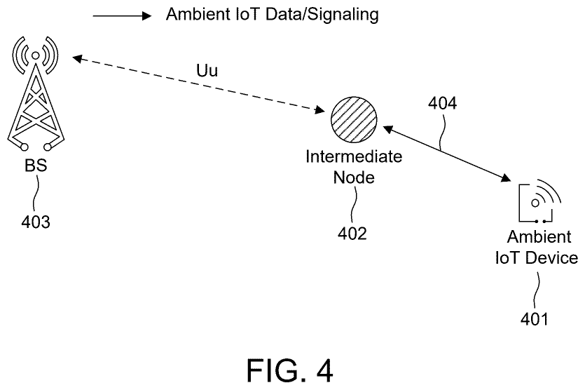

FIG. 4 depicts the architecture of another example of a topology of an AIoT system-Topology 2.

In topology 2, the AIoT device 401 may communicate with an intermediate node 402, and the intermediate node 402 may communicate with the base station 403. The intermediate node 402 may be, for example, a relay, an IAB node, a UE, an WTRU, or a repeater. The intermediate node may be referred to as intermediate WTRU. The intermediate WTRU 402 may have the capability of communicating with the base station (e.g., over the Uu interface) and of communicating directly with the AIoT device 401, over the AIoT interface 404 (e.g., using RFID). The intermediate WTRU 402 may process and then relay the information between the base station 403 and the AIoT device 401. The communication between the nodes may be bidirectional, allowing for data and/or signaling in both directions.

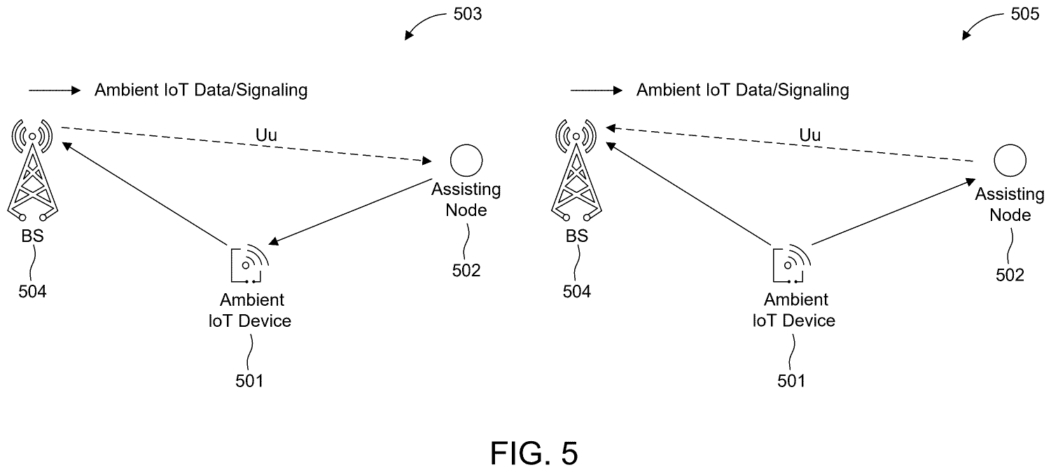

FIG. 5 depicts the architecture of another example of a topology of an AIoT system-Topology 3.

In topology 3, the AIoT device 601 may communicate using an assisting node 502. The assisting node 502 may be for example, a WTRU, a relay, an IAB, an UE, a repeater. The assisting node may be capable of AIoT communication. In one example, the assistance may be a downlink assistance 503. In the downlink assistance model, the AIoT 501 device may transmit data and/or signaling to the base station 504, and receive data and/or signaling from the assisting node 502. In another example, the assistance may be an uplink assistance 505. In the uplink assistance model, the AIoT device 501 may receive data and/or signaling from a base station 504 and transmit data and/or signaling to the base station and to the assisting node 502.

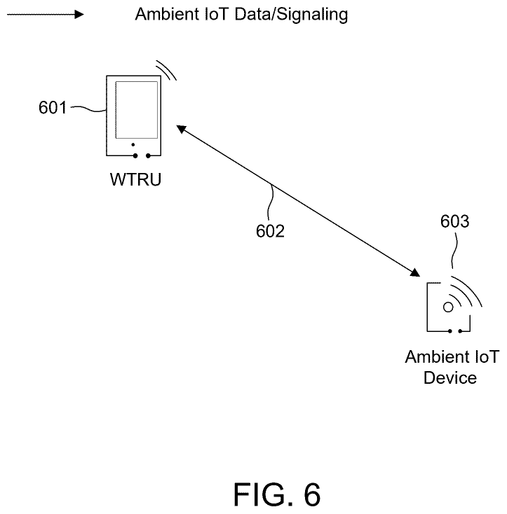

FIG. 6 depicts the architecture of another example of a topology of an AIoT system-Topology 4.

In topology 4, the AIoT device 601 communicates bidirectionally 602 with a UE 603. The communication between UE and the ambient IoT device includes Ambient IoT data and/or signaling.

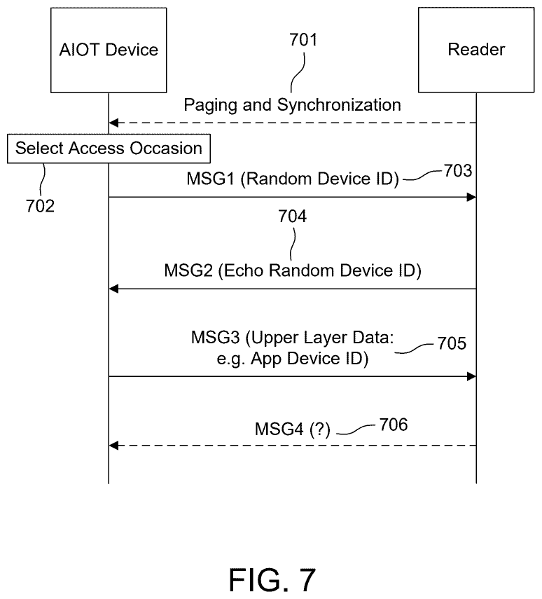

FIG. 7 illustrates the AIoT random access framework.

The reader sends a paging message and a set of occasion synchronization messages 701. The paging message comprise the device IDs of the devices that are to respond to the paging. The synchronization message configures/delimits the random access occasions for transmissions by the AIoT devices.

An AIoT device selects an access occasion 702 (using for example a slotted ALOHA framework), and transmits a random device ID in MSG1 703. The reader, upon successful reception of MSG1, transmits MSG2 704. MSG includes the random device ID received in MSG1.

If the device receives the echoed random device ID in MSG2, it transmits MSG3 705 containing upper layer control information, such as an application layer device ID. At this point, the contention is resolved, and the procedure completed. But a MSG4 706 may be transmitted by the reader, e.g., for subsequent command transmission.

In RFID, the paging is based on a long device ID, which is unique for a device. The use of a shorter temporary device ID, such as the currently used Cell Radio Network Temporary Identifier (C-RNTI) assigned by the AS layer, may be beneficial to make subsequent operations more resource efficient. However, there are shortcomings of this mechanisms in AIoT.

While the existing mechanism of C-RNTI assignment during the RACH procedure works well for NR, where device power consumption is a limited concern (as compared to an AIoT device), it may not be feasible for devices in AIoT having stringent power consumption limitations. Specifically, such AIoT devices may not have the capability of storing the temporary IDs, e.g., due to limited storage space. In addition, the implementation of the functionality of receiving a temporary ID from the network and then saving it in local memory may be too complex for such simple devices which have limited processing capabilities. Furthermore, due to power limitations, a device which is not energized may lose some of its storage, and the reader may have no knowledge of when this occurs and no knowledge that a new temporary ID needs to be assigned to the device that lost its previous temporary ID.

Temporary ID assignment may further be complicated in the case of topology 2, due to the presence of multiple readers, which may each be able to reach a specific device. If the gNB selects the temporary ID for each device, this can ensure that the IDs are assigned uniquely. However, this introduces a burden on the intermediate UE to always be in RRC connected mode during the assignment, which may be undesirable.

As a result of these factors, a need for a mechanism for assignment of a temporary AS layer device ID was identified. In other words, it is desired to enable a procedure to assign and manage unique temporary AS layer device IDs to devices while taking into account the limited device capabilities (e.g., storage, energy) and the system topology (e.g., especially for topology 2 or topology 4).

The term “reader” refers to the entity which queries the AIoT device, either directly, or via an intermediate node (e.g., WTRU, UE), as in topology 2. The term reader, in topology 2, may also refer to the intermediate WTRU. As a result, the term reader may refer to a network node or a WTRU, depending on the context and/or the topology.

The terms “reader,” “WTRU reader,” “intermediate node,” and “intermediate WTRU” are used interchangeably to mean the reader or an intermediate node, based on the scope of the solution being described.

The terms “device,” “tag,” and “AIoT WTRU” are used interchangeably to mean the AIoT device that is being inventoried/queried by the reader.

The term “occasion” refers to the opportunity for device transmission that may be delimited by the transmission of a query rep message (or similar). Specifically, a device may perform transmission in an occasion by performing a AIoT transmission in a defined time following the query rep associated with that transmission. Alternatively, an occasion may consist of both a time aspect and a frequency aspect. Specifically, a device may determine an occasion as a transmission following a specific query rep, and by transmitting on one of a number of frequencies (e.g., FDM). Wherever solutions indicate selection of an occasion, they can apply equivalently to selection of only a time component and/or selection of a frequency component.

Any reference to “time” may indicate an absolute time measurement (e.g., seconds, slots, frames) or it may indicate a number of executions of a procedure, possibly triggered by a reader (e.g., number of inventory procedures, number of accesses or RACH procedures). Alternatively, it may indicate a number of messages, possibly of a specific type, or containing specific information, received or transmitted.

The terms “configuration” or “pre-configuration” may refer to any configuration received by a message (e.g., an RRC message, a MAC CE, a PHY layer signal, a data PDU, a control PDU associated with any existing or new protocol layer) received from either a network node, or from another device or UE or WTRU. The term pre-configuration may optionally refer to the process of pre-provisioning information is a device or UE or WTRU.

The term “inventory” refers to the overall procedure of a reader triggering access by multiple devices using a sequence of messages (e.g., similar to query, followed by query rep in RFID). Specifically, the inventory procedure refers to a single round of attempts to have each device respond or attempt to respond with its access ID, or perform a RACH procedure. Specifically, the inventory procedure refers to a set of access occasions which may have 0 or at least 1 device respond within the access occasion.

The term “device ID” is used in the solutions' descriptions. The device ID may consist of a permanent device ID assigned to the device during provisioning, or configuration, or provided by the application layer. The device ID may be assigned by the base station (e.g., gNB), or assigned by an intermediate WTRU. For security and privacy reasons, the device ID used in the random access procedure may be an encrypted or encoded version of any of the possible device IDs. An “AS layer device ID is an ID assigned by the Access Stratum (AS). A “CN device ID” is an ID assigned by the Core Network (CN). An “application device ID” is an ID assigned by the application being used. The “AS layer device ID” may be a temporary ID.

A “known device” is a device that has previously responded to an inventory. An “unknown device” is a device that is being paged with an ID without knowledge of whether the device is present or will respond. The terms known and unknown devices may also refer to whether or not there is a context for the device (e.g., and ID) stored at the reader or network.

An “inventory procedure” may occur similar to legacy RFID procedure. Although referred to as inventory procedure, it may be termed differently in device requirements or specifications (e.g., query procedure, paging procedure, tracking procedure). The inventory procedure may be triggered by an application hosted in the network, in which case it may reach the AIoT device via an intermediary UE (e.g., in topology 2). An inventory procedure may also be triggered autonomously by the UE, for the case the UE is a reader (e.g., topology 4). Optionally, the inventory procedure may be triggered by the UE based on a message received from another UE (e.g., in the sidelink channel).

In topology 4, the UE may be pre-configured or pre-provisioned with parameters associated with the inventory procedure. Optionally, the UE may receive such parameters from the base station (e.g., gNB) when it is in RRC connected mode. The UE may also receive information from other UEs in proximity that may help with selecting parameters. Once the configuration parameters are received, the communication associated to device procedures between the UE and the network may be limited. The UE may mostly operate as a reader autonomously.

In topology 2, the UE is an intermediate UE and may communicate with the network throughout the device-to-UE procedures, updating the network based on device information received and receiving from the network information that is to be forwarded to the deice or used in the UE-to-device communication.

A tracking procedure is an inventory procedure that only includes MSG1. It may be used so that the UE can measure the signal received from the device. The procedure ends after MSG1 is transmitted.

The inventory procedure may occur similar to legacy RFID procedure. Although referred to as inventory procedure, it may be termed differently in device requirements or specifications (e.g., query procedure, paging procedure, tracking procedure). The inventory procedure may be triggered by an application hosted in the network, in which case it may reach the AIoT device via an intermediary UE (e.g., in topology 2). An inventory procedure may also be triggered autonomously by the UE, for the case the UE is a reader (e.g., topology 4). Optionally, the inventory procedure may be triggered by the UE based on a message received from another UE (e.g., in the sidelink channel).

In topology 4, the UE may be pre-configured or pre-provisioned with parameters associated with the inventory procedure. Optionally, the UE may receive such parameters from the base station (e.g., gNB) when it is in RRC connected mode. The UE may also receive information from other UEs in proximity that may help with selecting parameters. Once the configuration parameters are received, the communication associated to device procedures between the UE and the network may be limited. The UE may mostly operate as a reader autonomously.

In topology 2, the UE is an intermediate UE and may communicate with the network throughout the device-to-UE procedures, updating the network based on device information received and receiving from the network information that is to be forwarded to the device or used in the UE-to-device communication.

An inventory procedure may be triggered periodically or non-periodically, depending of the objective of the inventory. For instance, the UE may want to measure the signal received from the device based on a message transmitted by the device. In this case, a periodic AS layer trigger may be configured, in which case the device may transmit MSG1 periodically for measurement purposes, but not necessarily expect a response from the UE, as the sole purpose of MSG1 is for the UE to measure the received signal, and not necessarily to establish communication with the UE. On the other hand, if the UE wants to gather further information from the device, e.g., if the application triggers the request, an on-demand trigger may be used. An on demand trigger may trigger the transmission of MSG1 from the device, a response in MSG2 from the UE, followed by a MSG3, from the device, which may carry the information demanded.

Consider the case of implementation of an AIoT network using Topology 2, as illustrated in FIG. 4. In topology 2, the AIoT device may communicate with an intermediate node, and the intermediate node may communicate with the base station. The intermediate node relays information between the AIoT device and the base station. In one example, the intermediate node may be a UE. During a random access procedure, the intermediate node (e.g., UE) may determine whether to transmit an AS layer device ID assignment message (e.g., MSG4) based on whether a received random ID is currently used by another device managed by the UE and/or other UEs under the control of the base station (e.g., gNB). This information may be shared by the base station (e.g., gNB).

A UE may receive an inventory procedure configuration from the network comprising a time duration associated with performing measurement-based device tracking and a set of occasions associated with a split of resources (e.g., P1, P2, T1, T2).

The UE may initiate an AIoT inventory procedure by sending a paging message upon a trigger. The UE may include the resource split (P1, P2) for periodic trigger or (T1, T2) for on-demand trigger, in the paging message. The trigger may be, e.g., the reception of a CN message or an RRC message indicating the initiation of an inventory procedure or the expiry of time period associated measurement-based device tracking. The UE may transmit the trigger type and the information of the split resource sets to the AIoT device in the paging message.

The UE may determine a split of the AIoT inventory resources (e.g., into two sets where a specific number of occasions corresponds to the first set and another set of occasions corresponds to the second set) based on the trigger type, and the received configuration. For example: if the trigger is a periodic trigger, use P1 occasions for the first set and P2 occasions for the second set. Otherwise, use T1 occasions for the first set and T2 occasions for the second set and include the resource split in the paging message.

The UE may receive at least one message (i.e., AIoT MSG1) from an AIoT device in a resource and determine whether to respond to the device based on the trigger type and the resource set that the resource belongs. If the resource is in the second set (i.e., unknown device resource set) or the trigger type is not periodic (i.e., for measurement purposes), the UE may transmit the response message (i.e., AIoT MSG2), including the ID received from the device in AIoT MSG1. If AIoT MSG2 was transmitted (i.e. device ID assignment check), the UE may receive an AIoT MSG3 including an application device ID from the AIoT device, and the UE may then determine whether to transmit AIoT MSG4. The contents of the AIoT MSG4 are based on the AS layer device ID received in AIoT MSG1. For example, if the received AS layer device ID (in MSG1) matches one of the currently assigned device IDs, the UE may select an unassigned device ID and associate it with the application device ID received in AIoT MSG3.

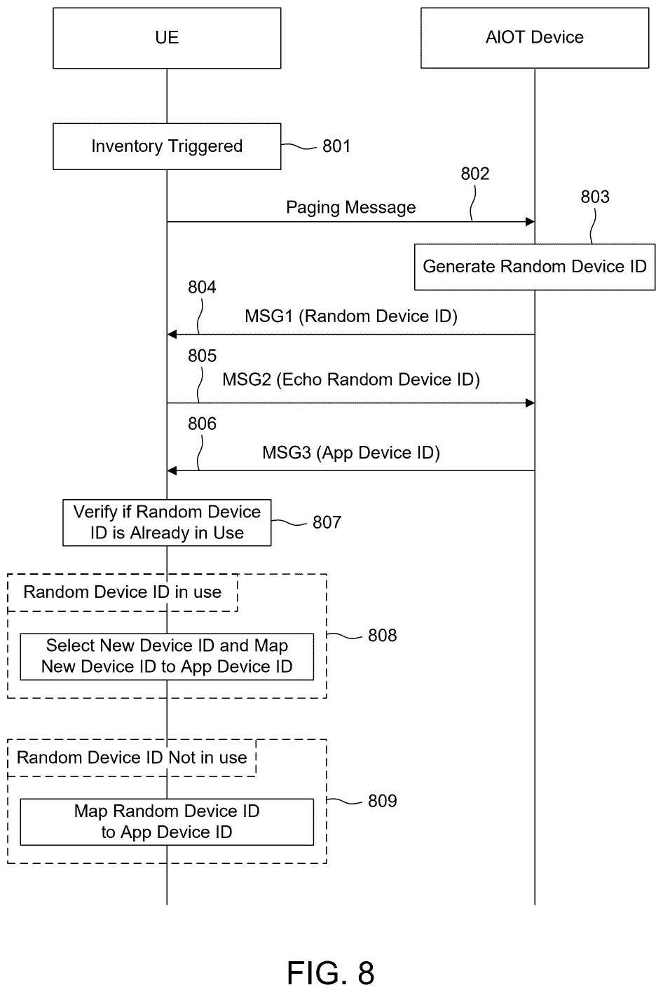

FIG. 8 illustrates the call flow of an example implemented in Topology 2. A UE (intermediate node) may receive a request to initiate an inventory initiation from a reader 801. The reader may be, e.g., another UE or an application running in the network side. Based on the received request, the UE sends a paging message 802 to the AIoT device. The AIoT device may generate a device ID 803 and send MSG1 804, as a response to the page. The AS layer device ID may be randomly generated. MSG1 may include the generated device ID. The UE may transmit MSG2 805, echoing the device ID received from the AOIT device in MSG1. The UE may receive an AIoT MSG3 including an application device ID from the AIoT device 806. The UE may verify if the generated device ID received in MSG1 matches one of the currently assigned device IDs 807. If so, the UE may select an unassigned device ID to associate with the application device ID received in MSG3.

In another example, the UE may determine whether or not to change the AS layer device ID based on a request from the network (e.g., when the UE is in Connected mode)

In another example, the UE may receive a list of “reserved IDs” from the network, which should not be assigned to a device as they are already being used or are reserved for the network to use it.

Depending on the number of UEs serviced by the same base station, the base station may divide the IDs in sub-sets of IDs and assign one sub-set to each UE as “available IDs”, which can be assigned to a device by the UE.

In another example, UEs may communicate with each on the sidelink channel and exchange information on reserved or available IDs.

When sending a paging message, a UE may transmit configuration information associated with AS layer device ID maintenance to the AIoT device. The UE may include different information/parameters in an AIoT paging message related to AS layer device ID maintenance.

The UE may include information identifying the reader in an AIoT paging message. For example, the UE may transmit a reader identity in the paging message. Such identity may be received from a network node. For example, the UE may receive a reader identity from the network from the RRC and may include that reader identity in the AIoT paging message. The UE may also include an existing Uu identity (e.g., C-RNTI, I-RNTI). In a distributed environment, the UE may select its own identity and send its ID to other UEs (e.g., via sidelink).

The UE may include, in the AIoT paging message, information identifying the system topology. For example, the UE/reader may indicate the topology to the device in the AIoT paging message. The topology may be indicated, e.g., in an implicit way. For instance, the lack of UE ID may indicate topology 1, inclusion of a cell ID instead of a UE ID may indicate topology 1, etc.

The UE may include, in the AIoT paging message, information identifying the trigger of the random access procedure. For example, the UE/reader may indicate what triggered the UE to initiate the random access (e.g., CN trigger, AS trigger) to the device in the AS paging message.

The UE may include, in the AIoT paging message, information identifying the type of random access procedure to be performed by the device. For example, the UE may initiate a different type of random access procedure for different purposes. Different random access types may be differentiated based on e.g., the number of exchanged messages, or the types of messages to be transmitted by the device and/or reader. For instance, one random access type may consist of transmission of only MSG1 by the device. Another random access type may consist of transmission of MSG1 followed by MSG3, if the device receives a valid MSG2. Different random access types may indicate whether the UE will transmit MSG4 or not. Different random access types may indicate whether the UE will transmit MSG2 or not.

Different random access types may also be differentiated based on e.g., the type of ID to be transmitted by the device. For example, one random access type may require the device to transmit a first type of ID (e.g., a random value, a local AS layer device ID) while the second type requires the device to transmit a second type of ID (e.g., a stored AS layer device ID, a global AS layer device ID). For instance, one random access type may consist of the device transmitting a known/assigned AS layer device ID in the first message, while another random access type may consist of the device transmitting a new/unknown (to the UE) ID in the first message.

Different random access types may be differentiated based on e.g., the set of resources that are to be used for transmission by the device. For example, one random access type may be associated with the device using the resources indicated by the UE in the R2D (reader to device) transmissions, while a second random access type may be associated with the device using predefined resources. Optionally, a rule may tie the resources for each message. For example, MSG1 is always transmitted in a first set of resources and MSG3 is always transmitted in a second set of resources.

Different random access types may also be differentiated based on e.g., the assumption on how to handle the storage/generation of the AS layer device ID to be used following the inventory procedure. In one example, the reader may indicate in the paging message for the device to release the stored AS layer device ID. In another example, the reader may indicate in the paging message for the device to replace its stored AS layer device ID with the AS layer device ID to be transmitted by the reader (e.g., in MSG2, in MSG4, etc.). In another example, the reader may indicate in the paging message for the device to use the ID which is the previously stored AS layer device ID.

Different random access types may be differentiated based on e.g., the waveform used for transmissions, the maximum signal power allowed, the duration of the transmission, or other physical layer characteristics of the signal transmitted by the device.

The UE may include, in the AIoT paging message, information on random access resources. For example, different AIoT devices may be allowed to perform different random access procedure types within the same inventory. The UE/reader may configure devices to perform different random access ID types in different resources during the same inventory procedure. The UE may indicate the resources associated with each random access type in the AIoT paging message.

The configuration information above may be included explicitly included in the AIoT paging message (e.g., using a dedicated field). Alternatively, the information may be implicit, based on other transmissions.

The information may be conveyed implicitly by using a different length of the paging message transmission and/or any preamble transmitted with the paging message.

The information may be conveyed implicitly by using a different length, range, or format of the paging device ID. For instance, a UE may trigger an inventory for measurement/tracking only by including a portion (subset) of the stored AS layer device ID, while a normal inventory may be triggered by providing the full AS layer device ID or an upper layer ID.

For instance, a UE may trigger one type of random access procedure in a device by including both the device's AS layer device ID and upper layer ID in the paging message, otherwise it may trigger another random access procedure in that device. For instance, a UE may trigger a different type of random access procedure by including the AS layer device ID versus the upper layer ID. For instance, a UE may trigger a device to release its AS layer device ID by including only the upper layer ID in the paging message.

The information may be conveyed implicitly by using different resource information (either number of resources, format of the resources, presence of certain resources, relationship between resources, etc.). For example, a UE may trigger a different type of random access procedure by using different resource information (either number of resources, format of the resources, presence of certain resources, relationship between resources, etc.). For instance, the UE may use a resource (associated with an index or offset) to implicitly provide to the device the offset value in order to be used for other purposes (e.g., the derivation of the device ID to store by the device, an indication of the command to perform at the device, an indication of the value of a control parameter to store at the device, an indication of a time (e.g., in the future) to perform another operation, etc.).

The information may be conveyed implicitly by the inclusion of a field (e.g., reader ID) in the paging message.

Without loss of generality, the above information may be included in any R2D (reader to device) message, including MSG2, MSG4, messages to synchronize the devices and/or define the access occasions, command messages, etc.

Upon receiving the paging message, the AIoT device may determine/select its own AS layer device ID.

A device that has no AS layer device ID assigned, or that is triggered by the reader to release is AS layer device ID, may determine its own ID. The device ID may be generated by a random generation process or may be randomly selected from a set of allowed IDs. The set of allowed IDs may be configured by the UE in the AIoT device, or pre-provisioned in the AIoT device.

In one solution, a device may indicate the selected AS layer device ID (i.e., the ID to be maintained at the device) to the reader. For example, the device may send the selected AS layer device ID in MSG1.

The device may store the AS layer device ID for future access (e.g., command message, tracking procedure, etc.) by the reader. A device may determine whether to store the selected ID as its AS layer device ID based on reception, or lack thereof, of a message or an ID received from the reader, during or after the random access procedure. For example, a device may select an ID (e.g., randomly) and transmit it in MSG1. The device may then store the selected ID following successful random access. Specifically, if the device succeeds random access (e.g., it receives MSG2 confirming or echoing the transmitted ID in MSG1), the device may store the ID for future access by the device.

Following the storage of the device ID, the device may respond to a paging message and include the device ID in any random access attempts (e.g., in MSG1)

The device may include the device ID in random access attempts where the paging message indicates to use the stored ID in MSG1 (e.g., random access for the purpose of tracking/measurements).

A device may autonomously release a stored AS layer device ID.

In one solution, when a device releases a stored AS layer device ID, the device may initiate a random access in the next attempt using a randomly selected ID, e.g., random number of a number of bits, possibly signaled by the reader. In another solution, after the device releases a stored AS layer device ID, the device may indicate to the UE/reader by including information (e.g., an explicit flag) in a device to reader (D2R) message. A device may be (pre) configured with triggers for releasing a stored AS layer device ID.

In one solution, a device may release a stored AS layer device ID and/or initiate random access in the next attempt without using an AS layer device ID (e.g., by generating a random number) based on any information or condition associated with the information received in the configuration (e.g., in the paging message).

For example, upon reception of a reader ID which is different from the reader ID received in the previous paging message (and/or inventory procedure), a device may release the stored AS layer device ID. Alternatively, if there is no change in the reader ID between subsequent inventory paging messages, the device ID may continue to initiate access with the AS layer device ID.

For example, upon reception of a paging message without a reader ID, the device may release the stored AS layer device ID. Alternatively, if the paging message contains a reader ID, the device may maintain the AS layer device ID.

For example, a device may release an AS layer device ID following explicit indication by the reader. For example, such explicit indication may come in MSG4 (i.e., after the device has succeeded the random access). In another example, such indication may come in a dedicated command to the device.

For example, a device may release an AS layer device ID following a number of events related to AIoT operation. The event may be associated with the number of received messages from the reader, possibly of a specific type (e.g., command, sync, etc.). The event may be associated with the number of failed random access procedures, where a failed random access procedure consists of transmitting MSG1 (with the expectation of receiving a response in MSG2) and not receiving MSG2 prior to the occurrence of another event (expiry of a timer, reception of a specific message type from the reader). The event may be associated with a time duration that the device ID remained stored. The event may be associated with the number (possibly one) of triggers by the device of an autonomous random access.

In one solution, a device may release a stored AS layer device ID at the end of an inventory procedure. For example, a paging message may indicate a number of time occasions associated with the inventory procedure. Each inventory occasion may be associated with a R2D transmission. Following reception of the last R2D transmission associated with the inventory occasion, the device may release the stored AS layer device ID.

In another solution, a device may release the stored AS layer device ID at the end of the occasion where the device succeeded the random access. For example, the device may store the AS layer device ID upon reception of MSG2 with the echoed ID from MSG1. Upon reception of a R2D message signaling the end of an occasion (e.g., MSG4, sync/occasion message), the device may release the stored AS layer device ID. Until reception of such message, the device may respond to unicast messages transmitted by the reader. Specifically, the reader may transmit command messages addressed to the AS layer device ID (i.e., the message may contain the AS layer device ID). Specifically, the device may decode and respond to command messages containing the AS layer device ID, until such ID is released.

In another solution, a device may release a stored AS layer device ID following a time duration since the ID was last used by the device (e.g., in MSG1). A device may release a stored AS layer device ID following a time duration since the ID was echoed by the reader (e.g., in MSG2). A device may release a stored AS layer device ID following a time duration since the start/end of inventory procedure where the device stored the AS layer device ID. A device may release a stored AS layer device ID following a time duration since the start/end of the time occasion where the device stored the AS layer device ID. The device may start a timer at the time it stored the AS layer device ID and, upon expiry of the timer, the device may release its AS layer device ID.

In another solution, a device may release the stored AS layer device ID based on conditions associated with stored energy. Specifically, a device may release the stored AS layer device ID upon depletion of its energy. In another example, a device may release the stored AS layer device ID when its stored energy falls below a threshold. In another example, a device may store an AS layer device ID as long as the device is energized by an external carrier wave (CW) or energy source. Upon lack of such energy source, the device may release the stored AS layer device ID.

A device may replaces a stored AS layer device ID with one provided by the reader.

In one solution, the device may replace a stored AS layer device ID with one provided by the UE/reader. Specifically, the UE/reader may provide an AS layer device ID during the random access procedure, or following the procedure. For example, the reader may send a dedicated message to the device (e.g., MSG4) which assigns a AS layer device ID. The reader may identify the message with the device ID received in MSG1 (to identify the device in the procedure) but the message may also contain an AS layer device ID. If the device receives MSG4 with a device ID, it may store the device ID as the ID to use as the stored AS layer device ID. Otherwise, if the device does not receive MSG4, it may store the ID it transmitted in MSG1 as the stored AS layer device ID.

In one example, the network may configure a time duration for all the AS layer devices IDs, and the ID expires when the time duration expires (e.g., the UE may run a timer for each AS layer device ID). Optionally, the UE may report an AS layer device ID to the network upon assignment to a device, and the network may assign a time duration and inform the UE via an RRC message of the time duration for that ID. In this case, different time durations may be assigned to different AS layer device IDs. In MSG2, the UE includes the device ID from MSG1, to resolve any contention. But in MSG4, the UE may assign a new ID to the device, which will replace the one sent in MSG1 and MSG2.

Determination of the absence of MSG4 by the device may be based on the expiry of a timer at the device that starts after the transmission of MSG3. Determination of the absence of MSG4 by the device may be based on receiving, from the reader, another message (e.g., sync/occasion), possibly sent using a broadcast. Determination of the absence of MSG4 by the device may be based on receiving a subsequent unicast message from the reader, possibly addressed to the ID sent in MSG1, but not containing a device ID to replace the stored device ID.

The UE may maintain a list of AS layer device ID(s) for each device. In one solution, the UE may maintain a list of AS layer device IDs associated with each device. Such list may be referred to as a “device list.”

A UE may maintain, as part of the device list, a mapping between the AS layer device ID and the CN device ID or AP device ID (Note: CN device ID and AP device ID are used interchangeably to mean any ID or set of IDs assigned by a layer above the AS layer). Specifically, when receiving a trigger from the CN to initiate paging, inventory, command, etc., the UE may receive a CN device ID that is unique for that device. The UE may maintain, as part of the device list, the AS layer device ID that corresponds to each CN device ID. Upon assigning a new ID to a device, the UE may update the list.

A UE may use the information on the device list for paging and/or triggering a command to a device. Specifically, a UE may receive a triggering operation (e.g., command, inventory, inventory+command) from the upper layers, CN, or gNB containing one or more CN IDs. If one of the CN IDs received corresponds to an AS layer device ID in the device list, the UE may use the AS layer device ID to page the device. Otherwise, the UE may page the device with the received CN device ID.

The UE assigns an AS layer device ID to the device

A UE may trigger an access (e.g., inventory, inventory +command, etc.) in one or more devices. The UE may determine to assign a temporary AS layer device ID to the one or more of the devices during or immediately after the access by the device. The UE may assign a temporary AS layer device ID by transmitting the AS layer device ID to the device during the random access procedure. The ID may be sent as a control parameter in MSG2. Alternatively, the UE may send the ID in MSG4 (i.e., the message immediately after the completion of the random access). Alternatively, the UE may send the ID in a command message to the device, or any message that is intended specifically to one device. Specifically, if the UE decides to assign a temporary device ID, it may transmit a MSG4, otherwise it may not transmit a MSG4. Alternatively, if the reader decides to assign a device ID, it may include it in a R2D message.

In another example, a UE may assign a temporary ID implicitly based on the resources used to transmit a R2D message. For example, a time index and/or frequency index and/or time/frequency offset in the resource used for an R2D message (e.g., MSG4, e.g., MSG2) may indicate to the device to store as the AS layer device ID, some related offset or function of the ID sent in MSG1. For example, if MSG2 is a resource offset away from the expected resource for MSG2, the device may determine the AS layer device ID as the same (or as a related-e.g., multiple of a parameter) offset from the value of the ID in MSG1.

A UE may be configured with conditions on when to assign an AS layer device ID to a device.

In one example, the conditions associated to whether or not the UE should assign an AS device ID to a device may be based on the type of operation that triggered the UE to page the device. For example, a UE may determine whether to assign an AS layer device ID to a device based on the type of operation that was triggered by the core network and/or network. Specifically, a UE may initiate a random access procedure following a trigger from the upper layers, CN, or gNB (e.g., by receiving an RRC message, NAS message, application layer message, etc.). For example, if the operation is of a certain type, the UE may assign an AS layer device ID, otherwise, it may not assign such ID. For example, if the UE is asked to perform inventory+command operation and has received subsequent command information for a device, it may assign an AS layer device ID. On the other hand, if the UE is asked to perform inventory only, it may not assign an AS layer device ID.

For example, a paging message/inventory message may be triggered by the UE itself, or by the gNB (e.g., via RRC) as opposed to by the CN. A UE may determine whether to assign an AS layer device ID during/after such procedure with a device based on the origin of the trigger. For example, for AS (or UE) triggered operation, the UE may not assign/send an AS layer device ID. For example, for CN/application triggered paging message/inventory, the UE may assign/send a (new) AS layer device ID.

Information received by the UE in the paging trigger (and possibly sent by the UE to the devices).

For example, a UE may receive a set of parameters associated with the inventory/trigger message. For example, a UE may receive, in addition to the operation type, a set of IDs or a range of IDs to be included in the paging message. The UE may make the determination based on the format, length, number of devices, etc. received as part of the list of devices.

For example, a UE may receive an explicit indication from the network (e.g., in the form of a flag, e.g., in the form of a tracking timer-period of time over which the UE should repeat an inventory to perform localization of the device, etc.) and may assign an AS layer device ID based on whether or not it received this indication from the network.

The conditions associated to whether or not the UE should assign an AS device ID to a device may be based on information associated with paging trigger at the UE (which is possibly also sent by the UE to the devices). For example, a UE may receive, from the network, a set of parameters associated with the inventory/trigger message. For example, a UE may receive, in addition to the operation type, a set of AS layer device IDs to be included in the paging message. The UE may determine, based on the format, length, number of devices, etc. received, whether or not the UE should assign an AS device ID to a device.

For example, a UE may receive an explicit indication from the network (e.g., in the form of a flag, e.g., in the form of a tracking timer-period of time over which the UE should repeat an inventory to perform localization of the device, etc.) and may assign an AS layer device ID based on whether or not it received this indication from the network.

The conditions associated to whether or not the UE should assign an AS device ID to a device may be based on the device type and/or device capabilities. For example, a UE may receive, as part of the D2R signaling, an indication of the device type. The UE may be configured with certain device types for which the UE provides an AS layer device ID, and other device types in which a UE does not provide an AS layer device ID.

The conditions associated to whether or not the UE should assign an AS layer device ID to a device may be based on information (e.g., an ID) received in a D2R message, such as MSG1 (possibly after comparing with a stored value). For example, a UE may receive an ID in MSG1. Depending on the range/value of the received ID, a UE may assign/send an AS layer device ID. For example, a UE may receive configured device IDs from the network (e.g., in RRC signaling). Upon receiving MSG1, the UE may verify if the ID received in MSG1 is in the list of configured device IDs, or within a range of the configured device IDs.

In another example, the UE may maintain a list of AS layer device IDs (as described in previous paragraphs) and the UE may determine whether to assign a device ID based on whether the ID received in the D2R message (e.g., in MSG1) is one of the IDs in the list of device IDs.

In another example, a UE may receive, from the device, an explicit indication that it has released an AS layer device ID, and/or does not have a stored AS layer device ID. For example, a UE may receive an ID (e.g., in MSG1) which does not have the format of an AS layer device ID (e.g., based on the bit combination, length of the ID, etc.), in which case the UE may determine to assign/send an AS layer device ID to the device.

The conditions associated to whether or not the UE should assign an AS device ID to a device may be based on network signaling. For example, a UE may request from the network (e.g., in RRC signaling) an indication regarding to whether or not to assign/send an AS layer device ID to the device. For example, a UE may trigger an UL RRC message (e.g., UEAssistance, etc.) during or following successful random access with a device (e.g., to provide the network with the upper layer data in MSG3). If the network responds with an AS layer device ID to provide to the device, the UE may sent/assign an AS layer device ID to the device (e.g., by transmitting MSG4).

The conditions associated to whether or not the UE should assign an AS device ID to a device may be based on the UE's RRC state. For example, the UE may send an AS layer device ID while in RRC_INACTIVE, but not while in RRC_IDLE.

The conditions associated to whether or not the UE should assign an AS device ID to a device may be based on the UE location and/or speed. For example, a UE may be configured with an area (e.g., RAN area, SL- related zone, GPS coordinate range, etc.) in which it should (or should not) assign an AS layer device ID. For example, a UE may be configured to assign/send an AS layer device ID as long as its speed is below a threshold.

The conditions associated to whether or not the UE should assign an AS device ID to a device may be based on the time elapsed since the previous paging, or time elapsed since it received a response from a device. For example, a UE may determine whether to assign an AS layer device ID based on the time elapsed since the last response by the device, since the last time the device sent AS layer data, since the last time an inventory was triggered by the CN, and/or since the last time the UE assigned an AS layer device ID to the device. For example, the UE may be configured with a time duration value and when the time duration elapses, or if an access is triggered after the timer has expired, the UE may assign a (new) AS layer device ID. In one example, the AS layer ID is assigned in the next access after the timer expires. So the timer does not control the access, but controls whether during an access, the ID needs to be changed.

A UE may determine a value for the AS layer device ID based on network signaling. For example, the network may provide the UE with an AS layer device ID to provide to the device. In another example, the UE may suggest an AS layer device ID by sending an RRC message to the network, and the network may accept or reject the AS layer device ID selected by the UE, by sending a reply to the received RRC message, optionally included a new/different AS layer device ID. In another example, the network may provide one or more AS layer device IDs which are already assigned, and the UE may select an AS layer device ID which is not on that list. Conversely, the network may provide an allowed list of (new) AS layer device IDs and the UE may select from that list. In another example, the UE may maintain a list of AS layer device IDs (as described in previous paragraphs). The UE may select an AS layer device ID that is not contained in the device list. The selection may be random. The UE may then add this selected AS layer device ID to the device list as part of the list maintenance process.

A UE may determine a value for the AS layer device ID based on the CN device ID. For example, the UE may use a subset of the bits in the CN device ID, a function of the CN device ID, etc. to generate an AS layer device ID.

A UE may receive a set of available (or a set of already assigned) AS layer device IDs from another UE. For example, a second UE may broadcast its own list of assigned device IDs on sidelink. The UE may select an AS layer device ID that is not already assigned by another UE in proximity.

A UE may allow a device to select its own AS layer device ID. For example, the UE may receive an AS layer device ID in MSG1. Based on conditions similar to those above, the UE may store the ID as the (new) AS layer device ID for that device.

The new AS layer device ID may be assigned to the device using MSG4 or another message. Furthermore, the UE may add the new AS layer device ID to the device list, as part of the device list maintenance.

Device List with correspondence to CN ID

In one solution, a UE may determine whether to assign/send a new device ID based on the received ID (e.g., in MSG1) and the corresponding association of that ID to a CN ID in the device list (or lack of such association).

In one example, a UE may receive an ID (e.g., in MSG1) followed by a CN device ID (e.g., in MSG3). If the association between the ID in MSG1 and the CN ID in MSG3 exists in the device list, the UE may decide not to assign a new AS layer device ID (i.e., MSG4 is not sent). On the other hand, if the CN device ID (e.g., in MSG3) does not correspond to any devices in the device list, the UE may check if the received ID (e.g., in MSG1) is already associated with another device (with a different CN device ID) in the device list. The UE may select an unused ID and allocate to the device and send that ID in MSG4, to be used by the device as the AS layer device ID. Otherwise (i.e., if the received ID is not already associated with another device), and may assume the AS layer device ID of the device is the one received in MSG1, and the UE may not send MSG4. The UE may add the association of the AS layer device ID to the CN device ID in the device list.

When determining a new AS layer device ID, the UE may request one from the network. Specifically, if the ID in MSG1 is already assigned to another device, the UE may trigger a request for a new AS layer device ID from the network (e.g., in an UE Assistance RRC message). The network may provide an AS layer device ID to be used by the device, and the UE may provide the ID to the device (e.g., in MSG4).

When determining whether the ID in MSG1 is an acceptable AS layer device ID for the device, the UE may check with the network. Specifically, in the case the ID received in MSG1 is not present in the list of devices, the UE may send the ID to the network in an RRC message. If the network responds with a different ID, the UE may send the new ID to the device (e.g., in MSG4). Otherwise, it may assume the ID in MSG1 is the new AS layer device ID for the device. In each case, the UE may add the ID (and associated CN ID) to the device list.

Determination, by the network, of whether an AS layer device ID can be used may consist of
The UE selecting a device ID from a set of allowable device IDs provided by the network (e.g., in RRC or in SIB)
The UE selecting a device ID that is not in a set of unusable device IDs provided by the network (e.g., in RRC or in SIB)
Device List without correspondence to CN ID

In one solution, a UE may determine whether to assign/send a new AS layer device ID to a device (e.g., in MSG4) based on the AS layer device ID received from the device, and the device list.

In one example, a UE may receive an AS layer device ID in MSG1, along with an indication of whether the device generated the ID or if a stored AS layer device ID is being used. As described in previous paragraphs, the generation of the device ID may follow a random process. The indication sent by the device may be included as an explicit field. Alternatively, the indication may be included based on properties of the transmitted MSG1. For example, the UE may divide the resources for random access into two sets: a first set corresponding to random access performed by devices having a stored AS layer device ID (and using it in MSG1) and a second set of resources corresponding to random access performed by devices which do not have a stored AS layer device ID (e.g., the ID in MSG1 is randomly selected). A device ID may select a resource for MSG1 transmission based on whether it has a stored AS layer ID or not.

In one example, if the UE receives MSG1 from a device in the first set of resources (known AS layer device IDs), the UE may forward the information received in MSG3 without providing MSG4 to the device. If the UE receives MSG1 from a device in the second set of resources (unknown AS layer device IDs), the UE may:

If the ID in MSG1 corresponds to an AS layer device ID in the device list (e.g., the ID is already used), the UE may select an unused device ID and send it to the device in MSG4. If the ID is MSG1 does not conflict with a device ID in the list, the UE may assume the ID in MSG1 to be an assigned AS layer device ID. In each case, the UE may add any new AS layer device ID to the device ID list. The UE may further forward any new AS layer device ID to the network (e.g., in an RRC message)

In another example, rather than checking the device list, a UE may report the received MSG1 ID (e.g., in case it is an unknown device ID) to the network to determine whether a new AS layer device ID is needed.

In another example, rather than selecting an unused AS layer device ID from the device ID list, a UE may request a new AS layer device ID for the device from the network.

### Limited to Inventory Procedure

In one solution, a UE may determine whether to assign/send a (new) AS layer device ID in MSG4, based on the received ID in MSG1, and previously received IDs in MSG1 of other devices that have successfully completed random access before in the same inventory procedure (e.g., during a different occasion).

For example, a UE may receive an ID in MSG1. If the ID was not received in MSG1 (and confirmed in MSG2) by the UE in a previous occasion/resource, the UE may not respond using MSG4, and may assume the ID in MSG1 to be the AS layer device ID for the device. Otherwise, the UE may select a new device ID (not previously used by any device in the inventory procedure, and may send that ID to the device in MSG4). Alternatively, the UE may select a new device ID by requesting one from the network. The UE may report an assigned device ID to the network.

A UE may maintain a mapping of the CN device ID (e.g., received in MSG3) and the AS layer device ID (received in MSG1 or assigned in MSG4) which lasts during the inventory+command procedure duration. Specifically, subsequent to successful random access by a device, if the CN or gNB sends a command request to the

UE with a CN device ID, the UE may transmit the command over to the AIoT by utilizing the AS layer device ID (i.e., including the ID as the destination in the unicast message).

In another solution, in case the ID provided in MSG1 corresponds to an ID selected by another device in the same inventory procedure, the UE may ignore MSG1 (e.g., may not respond using MSG2). The device may then retry the random access procedure, potentially selecting (e.g., via a random selection) a new ID to include in MSG1.

### Device ID Management During Tracking

A UE may use the AS layer device ID as part of the tracking procedure. A UE may a trigger tracking procedure periodically (e.g., based on a configured time period). Alternatively, a UE may trigger tracking procedure when receiving an indication or message from the network. Alternatively, a UE may trigger a tracking procedure upon a state transition. Alternatively, a UE may trigger a tracking procedure upon a Uu mobility event, such as handover, conditional handover (CHO), layer 1 triggered measurements (LTM), cell reselection, movement by the UE by at least an absolute distance, RAN area update, tracking area update, or similar change in a group of cells the UE is camped on.

For example, a UE may periodically trigger an inventory procedure from all devices. Similar to previous solutions, a UE may split the resources for the random access procedures into two sets (possibly configured by the network). The division of the resource sets may be configured differently for tracking compared to for NW triggered inventory procedure. Specifically, a different set of parameters for the number of resources for known and unknown devices may be received from the network, and transmitted by the UE in the paging message.

A device may select a first set of resources for random access triggered by a tracking procedure when it has a stored AS layer device ID. The device may transmit the stored AS layer device ID in MSG1 when performing random access. The UE, upon reception of MSG1 from the devices in the first set of resources, may simply report the measurements of the MSG1 transmission, such as reference signal received power (RSRP) and the device ID.

A device may select a second set of resources for random access triggered by a tracking procedure when it does not have a stored AS layer device ID. The device may generate an AS layer device ID (e.g., randomly) and include in MSG1. The UE, upon reception of MSG1 transmission, may echo the received MSG1 to the device which wins the random access. The UE may further send a (new) AS layer device ID to the device. The UE may request the (new) AS layer device ID from the network. Alternatively, the UE may select an unused AS layer device ID from a device list. The UE may report the measurements, along with the new AS layer device ID, to the network, for the devices responding in the second set of resources.

In another alternative, rather than using a separate set of resources for known and unknown devices, the device may explicitly indicate whether it uses an AS layer device ID or a generated AS layer device ID in MSG1.

A UE determines whether to transmit an AS layer device ID assignment message (e.g., MSG4) based on whether an AS layer device ID received from a device is currently used by another device managed by the UE and/or other UEs under the control of the gNB. The received AS layer device ID may be randomly generated by the device.

An intermediate UE (e.g., in topology 2) receives an inventory procedure configuration information from the network. The inventory procedure configuration information includes a time duration (e.g., timer) associated with performing measurement-based device tracking and a set of occasions associated with a split of resources (e.g., P1, P2, T1, T2). The UE initiates a transmission of a paging message (i.e., triggers an AIoT inventory procedure) upon any of the following triggers the reception of a CN message or an RRC message that initiates an inventory procedure, the expiry of time period associated measurement-based device tracking.

The UE transmit the trigger type and the information of the split resource sets in the AIoT paging

message. The UE determines a split of the AIoT inventory resources (e.g., into two sets where a specific number of occasions corresponds to the first set and another set of occasions corresponds to the second set) based on the trigger type, and the received configuration. For instance, if the trigger is a periodic trigger, use P1 occasions for the first set and P2 occasions for the second set. Otherwise, use T1 occasions for the first set and T2 occasions for the second set. The UE may include the resource split in the paging message.

The UE may receive at least one message (e.g., AIoT MSG1) from a device in a resource and determine whether to respond to the device based on the trigger type and the resource set in which the resource belongs. If the resource is in the second set (i.e., unknown device resource set) or the trigger type is not periodic (i.e., for measurement purposes), the UE may transmit the response message (i.e., AIoT MSG2) by including the ID received from the device in AIoT MSG1. Otherwise, do not transmit the response message.

If an AIoT MSG2 was transmitted (i.e. device ID assignment check), the UE may receive an application device ID (e.g., AIoT MSG3) from the device, and determine whether to transmit AIoT MSG4, and the contents of AIoT MSG4 based on the AS device ID received in AIoT MSG1. For instance, if the received AS device ID (in MSG1) matches one of the currently assigned device IDs, the UE may select an unassigned device ID and associate it with the application device ID received in AIoT MSG3. The UE may transmit AIoT MSG4 containing the selected device ID. Otherwise, the UE may not transmit AIoT MSG4.

In another alternative, the determination of whether to change the AS device ID may be based on request to the network (e.g., when the UE is in Connected mode).

In another alternative, the UE may receive a list of “reserved IDs” from the network

The UE receives inventory configuration information from the network (e.g., in an RRC message). Optionally, the UE receives information associated with inventory procedures from other UEs in proximity. The information received from other UEs in proximity may be in addition to the information received from the network.

In an example, the inventory configuration information may comprise a timer representing the periodic time period in which the UE should repeat a tracking procedure. In an example, the inventory configuration information may comprise information on a split of the resources between known and unknown devices, for each type of trigger. For example, the UE may receive a first set of resources P1 and a second set of resources P2, corresponding to the number of resources to be used for known and unknown devices, respectively, during an inventory triggered periodically, and another first and second set of resources, T1 and T2, also to be used by known and unknown devices, but during an inventory procedure that is triggered aperiodically (i.e., on demand).

The UE initiates transmission of a paging message on the AIoT interface. In one example, such transmission may be triggered by either periodic expiry of the tracking procedure timer, or by an inventory/command request received from the CN or application layer. The trigger occurs in the UE and the UE may send a paging message. Depending on the type trigger, the UE determines the split of resources for AIoT random access between a known and an unknown of device. The UE sends the resource information and the trigger type in the paging message.

The UE receives MSG1 from a device and determines whether to respond to the device in MSG2 (e.g., echoing the device ID received in MSG1, in MSG2). In one example, the UE may respond with MSG2 in all cases, except for the case where the trigger type was periodic, solely for measurement purposes, and MSG1 was received in the appropriate set of resources. When responding with MSG2, the device echoes the ID received in MSG1. In one example, the UE may report measurements to the network, along with the device ID. When not responding with MSG2, the procedure ends. The UE may use the device ID received in MSG1 as the AS layer device ID.

For the cases where the UE has responded with MSG2, the UE receives MSG3 with a CN device ID. The UE may then respond with MSG4, in the case the UE needs to assign a (new) AS layer device ID to the device. In one example, if the device used a randomly generated ID in MSG1, and if the randomly generated ID used in MSG1 is already assigned to a device, the UE may select a new device ID (that is unassigned) and may provide in in MSG4. After sending MSG4, the procedure ends. The UE may use the device ID sent in MSG4 as the AS layer device ID.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, WTRU, terminal, base station, RNC, or any host computer.

What is claimed:

1. A method performed by a wireless transmit and receive unit (WTRU), the method comprising:
receiving, from a network, ambient Internet of things (AIoT) resource configuration information;
determining, at the WTRU, based at least on the AIoT resource configuration information, a first set of resources reserved for AIoT devices that have been assigned an access stratum (AS) layer device ID by the WTRU, and a second set of resources reserved for AIoT devices that have not been assigned an AS layer device ID by the WTRU;
broadcasting an AIoT paging message;
receiving, from a first AIoT device, a first message using a first resource, wherein the first message includes an indication of a first AS layer device identity (ID) and wherein the first resource is associated with the first set of resources;
receiving, from a second AIoT device, a second message using a second resource, wherein the second message includes an indication of a second AS layer device identity (ID) and wherein the second resource is associated with the second set of resources;
transmitting, to the second AIoT device, a third message including the second AS layer device ID;
receiving, from the second AIoT device, a fourth message including a higher layer device ID;
transmitting, to the second AIoT device, a fifth message including a third AS layer device ID; and
transmitting, to the network, a sixth message including the first AS layer device ID and the third AS layer device ID.

2. The method of claim 1, wherein the AIoT paging message is periodically sent as part of a periodic measurement procedure at the WTRU.

3. The method of claim 2, wherein the configuration information further comprises a period for the periodic measurement procedure.

4. The method of claim 1, wherein the configuration information is received in a radio resource control (RRC) message.

5. The method of claim 1, wherein a higher layer device ID comprises a core network (CN) device ID or an application layer device ID.

6. The method of claim 1, wherein the AIoT paging message includes information associated with the first set of resources and the second set of resources.

7. The method of claim 1, further comprising:
storing a device list, wherein the device list includes known AS layer device IDs and their associated higher layer device ID.

8. The method of claim 7, further comprising:
upon sending the fifth message, updating the device list by adding the third AS layer device ID and the higher layer device ID; and
associating the third AS layer device ID to the higher layer device ID.

9. A method performed by a wireless transmit and receive unit (WTRU), the method comprising:
receiving, from a network, ambient Internet of things (AIoT) resource configuration information and AS layer device ID information including already assigned AS layer device IDs and their time validity duration;
determining, at the WTRU, based at least on the AIoT resource configuration information, a first set of resources reserved for AIoT devices that have been assigned an access stratum (AS) layer device ID by the WTRU;
broadcasting an AIoT paging message;
receiving, from an AIoT device, a first message using a first resource, wherein the first message includes an indication of a first AS layer device identity (ID) and wherein the first resource is associated with the first set of resources;
determining, upon receiving the first message, based on information of already assigned AS layer device IDs and their time validity duration, that the first AS layer device ID is no longer valid;
transmitting, to the first AIoT device, a second message including a second AS layer device ID; and
transmitting, to the network, a third message including the second AS layer device ID.

10. A wireless transmit and receive unit (WTRU), the WTRU comprising:
at least one transceiver;
at least one processor;
wherein the at least one transceiver and at least one processor are configured to:
receive, from a network, ambient Internet of things (AIoT) resource configuration information;
determine, at the WTRU, based at least on the AIoT resource configuration information, a first set of resources reserved for AIoT devices that have been assigned an access stratum (AS) layer device ID by the WTRU, and a second set of resources reserved for AIoT devices that have not been assigned an AS layer device ID by the WTRU;
broadcast an AIoT paging message;
receive, from a first AIoT device, a first message using a first resource, wherein the first message includes an indication of a first AS layer device identity (ID) and wherein the first resource is associated with the first set of resources;
receive, from a second AIoT device, a second message using a second resource, wherein the second message includes an indication of a second AS layer device identity (ID) and wherein the second resource is associated with the second set of resources;
transmit, to the second AIoT device, a third message including the second AS layer device ID;
receive, from the second AIoT device, a fourth message including a higher layer device ID;
transmit, to the second AIoT device, a fifth message including a third AS layer device ID; and
transmit, to the network, a sixth message including the first AS layer device ID and the third AS layer device ID.

11. The WTRU of claim 10, wherein the AIoT paging message is periodically sent as part of a periodic measurement procedure at the WTRU.

12. The WTRU of claim 11, wherein the configuration information further comprises a period for the periodic measurement procedure.

13. The WTRU of claim 10, wherein the configuration information is received in a radio resource control (RRC) message.

14. The WTRU of claim 10, wherein a higher layer device ID comprises a core network (CN) device ID or an application layer device ID.

15. The WTRU of claim 10, wherein the AIoT paging message includes information associated with the first set of resources and the second set of resources.

16. The WTRU of claim 10, wherein the at least one transceiver and at least one processor are further configured to:
store a device list, wherein the device list includes known AS layer device IDs and their associated higher layer device ID.

17. The WTRU of claim 16, wherein the at least one transceiver and at least one processor are further configured to:
upon sending the fifth message, update the device list by adding the third AS layer device ID and the higher layer device ID; and
associate the third AS layer device ID to the higher layer device ID.
